(19) United States
(12) Patent Application Publication
(10) Pub. No.: US 2014/0285094 A1
(43) Pub. Date: Sep. 25, 2014

(54) Light Dimming System

(71) Applicant: Toshiba Lighting & Technology Corporation, Yokosuka-shi (JP)

(72) Inventor: Kazuaki Itami, Yokosuka-shi (JP)

(73) Assignee: Toshiba Lighting & Technology Corporation, Yokosuka-shi (JP)

(21) Appl. No.: 14/023,504

(22) Filed: Sep. 11, 2013

(30) Foreign Application Priority Data
Mar. 22, 2013 (JP) 2013-059434

(51) Int. Cl. H05B 37/02

(52) U.S. Cl. CPC H05B 37/02
USPC 315/152

(57) ABSTRACT

A light dimming system includes a plurality of luminaires, an illuminance measuring unit configured to measure illuminances of the respective luminaires, and a dimming signal output device. The dimming signal output device includes a main control unit, a correction-table-data creating unit configured to calculate, for each of the luminaires, delay times until the luminaires reach specific illuminance ratios, set the delay time of selected one of the luminaires as a reference value, create correction table data from differences between the delay times for the luminaires and the reference value, and store the correction table data, and an output control unit configured to output the dimming control signals to the luminaires side at timings based on the differences of the correction table data.

### CROSS-REFERENCE TO RELATED APPLICATIONS

This application is based upon and claims the benefit of priority from the prior Japanese Patent Application No. 2013-059434, filed on Mar. 22, 2013, the entire contents of which are incorporated herein by reference.

### FIELD

Embodiments described herein relate generally to a light dimming system including a plurality of luminaires, transmission routes for transmitting a dimming signal to which are different or in which different kinds of light sources are disposed.

### BACKGROUND

As lighting for rendering on a stage, a studio, and the like, a luminaire including, as a light source, a light-emitting diode is used, power consumption of which is small, the life of which is long, and color light of which can be selected. A luminaire including a halogen lamp (an incandescent lamp) as a light source is also used. The light-emitting diode and the halogen lamp are dimmed and lit according to a dimming signal output from a controller (an operation device). The light-emitting diode and the halogen lamp are respectively dimmed and lit by dimmers therefor.

When the light-emitting diode and the halogen lamp are dimmed and lit for use in the same place, since respective dimming curves of the light-emitting diode and the halogen lamp are different, an electric current flowing to the light-emitting diode is adjusted to change a dimming level of the light-emitting diode so that an optical output ratio of the light-emitting diode is the same as an optical output ratio of a dimming level of the halogen lamp.

However, respective build-up curves of the light-emitting diode and the halogen lamp are different. The light-emitting diode and the halogen lamp are respectively dimmed and lit by the dimmers therefor. Therefore, times from a point when the dimming signal is output from the controller until the light-emitting diode and the halogen lamp start to be lit and times for build-up to a predetermined illuminance ratio of the light-emitting diode and the halogen lamp are respectively different. There is a problem in that inconsistency of lighting timings occurs. In particular, according to diversification of communication, a plurality of intermediate apparatuses such as communication converters for Ethernet (registered trademark) and RS485 and combiners for data protocols and signals are interposed between the controller and the luminaire. The number of interposed intermediate apparatuses is different for each of luminaires. Therefore, the inconsistency of the lighting timings conspicuously appears.

### BRIEF DESCRIPTION OF THE DRAWINGS

FIG. 1 is a schematic block diagrams of a light dimming system according to an embodiment; and

FIG. 2 is a schematic block diagram of a dimming signal output device according to the embodiment.

### DETAILED DESCRIPTION

In view of the above circumstances, it is an object of an embodiment to provide a light dimming system that can suppress inconsistency of lighting timings of a plurality of luminaires that include different kinds of light sources or to which dimming control signals are transmitted via different transmission routes.

The light dimming system according to this embodiment includes an operation device, a plurality of luminaires, an illuminance measuring unit, and a dimming signal output device.

The operation device outputs a dimming signal corresponding to a dimming operation level according to operation. Dimming control signals corresponding to the dimming signal output from the operation device are transmitted to the plurality of luminaries through different transmission routes and optical outputs of light sources of the luminaires are controlled. Alternatively, the plurality of luminaires include different kinds of light sources. The illuminance measuring unit can measure the illuminances on a surface to be irradiated by the respective luminaires. The irradiated surface may be different surfaces corresponding to respective luminaires or may be the same surface. The illuminance measuring unit is, for example, an illuminance meter.

The dimming signal output device includes a main control unit, a correction-table-data creating unit, and an output control unit. The main control unit generates the dimming control signals corresponding to the dimming signal output from the operation device and outputs the dimming control signals to the plurality of luminaires side.

The correction-table-data creating unit calculates, on the basis of illuminances measured by the illuminance measuring unit when the light sources of the respective luminaires are it according to the dimming signal output from the operation device, delay times from an output point of the dimming control signals until the luminaire reaches a specific illuminance ratio, creates, with a delay time of a selected luminaire set as a reference value, correction table data from differences between the delay times for the plurality of luminaires and the reference value, and stores the correction table data. The correction table data may be the difference value itself.

The output control unit outputs the dimming control signals output from the main control unit to the plurality of luminaires side at timings based on the respective differences of the correction table data.

With the light dimming system according to this embodiment, the dimming control signals output from the main control unit of the dimming signal output device are output to the plurality of luminaires side at the timings respectively based on the differences of the correction table data. Therefore, it can be expected that the plurality of luminaires to which the dimming control signals are transmitted via different transmission routes and optical outputs of the light sources are controlled or that include different kinds of light sources can match timings when the light sources are lit at a specific illuminance ratio.

Embodiments are explained below with reference to the drawings. First, a first embodiment is explained.

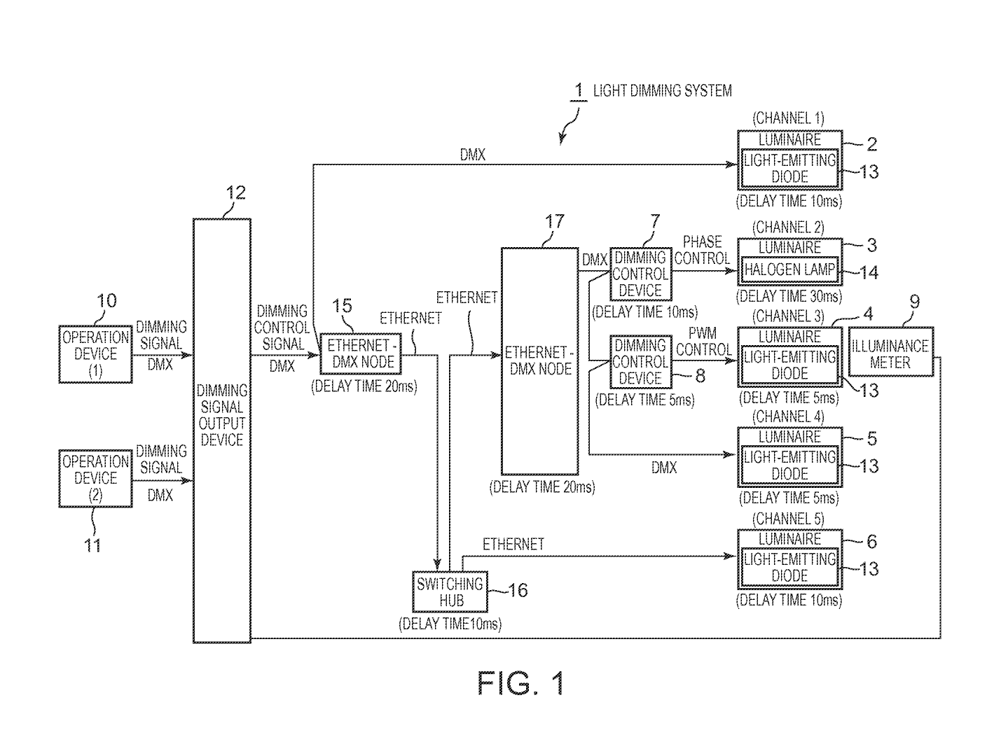

A light dimming system 1 according to this embodiment includes, as shown in FIG. 1, a plurality of luminaires 2 to 6, dimming control devices 7 and 8, an illuminance meter 9 functioning as an illuminance measuring unit, operation devices 10 and 11, and a dimming signal output device 12.

At least two among the plurality of luminaires 2 to 6 respectively include different kinds of light sources. In this embodiment, the luminaire 2 and the luminaires 4 to 6 are respectively configured as LED luminaires including light-emitting diodes 13 as the light sources. The luminaire 3 is configured as an incandescent luminaire including a halogen lamp 14 as the light source. The luminaires are respectively formed by known configurations. One or a plurality of each of the plurality of luminaires 2 to 6 are provided. In this embodiment, numbers of channels 1 to 5 are respectively given to the plurality of luminaires 2 to 6,

In the luminaire 2 and the luminaires 4 to 6, not-shown lighting circuit that light the light-emitting diodes 13 are respectively disposed. A form of use of the light-emitting diodes 13 may be any form such as a bulb or a light-emitting module mounted on a substrate. The plurality of luminaires 2 to 6 respectively radiate predetermined color lights.

The dimming control devices 7 and 8 are also referred to as dimmers and are respectively provided to correspond to the luminaires 3 and 4. That is, the dimming control device 7 is connected to the luminaire 3 and the dimming control device 8 is connected to the luminaire 4. Dimming control signals output from the dimming signal output device 12 are input to the dimming control devices 7 and 8 as DMX signals.

The dimming control device 7 is formed by a known configuration for phase-controlling, according to the dimming control signal, an alternating-current voltage input from a not-shown alternating-current power supply and supplying the phase-controlled alternating-current voltage to the halogen lamp 14. That is, the dimming control device 7 controls an optical output (a dimming level) of the halogen lamp 14 according to the input dimming control signal.

The dimming control device 8 is formed by a known configuration for generating a PWM signal having on-duty corresponding to the input dimming control signal and outputting the PWM signal to a not-shown lighting circuit of the luminaire 4. The lighting circuit lights the light-emitting diode 13 at a dimming level corresponding to the on-duty of the PWM signal. That is, the dimming control device 8 controls an optical output (a dimming level) according to the input dimming control signal.

Not-shown lighting circuits of the luminaire 2, the luminaire 5, and the luminaire 6 have a function same as the function of the dimming control device 8. That is, the dimming control signal output from the dimming signal output device 12 is input to the luminaire 2 as a DMX signal. The lighting circuit of the luminaire 2 controls an optical output (a dimming level) of the light-emitting diode 13 according to the input DMX signal and lights the light-emitting diode 13. The dimming control signal is input to the luminaire 5 as a DMX signal. The lighting circuit of the luminaire 5 controls an optical output (a dimming level) of the light-emitting diode 13 according to the DMX signal and lights the light-emitting diode 13. The dimming control signal is input to the luminaire 6 as a signal of an Ethernet protocol. The lighting circuit of the luminaire 6 controls an optical output (a dimming level) of the light-emitting diode 13 according to the signal of the Ethernet protocol and lights the light-emitting diode 13. In this way, the dimming control devices 7 and 8 are provided to correspond to the luminaires 3 and 4. The function of the dimming control device 8 is provided in the lighting circuits of the luminaire 2 and the luminaires 5 and 6 to respectively correspond thereto.

The illuminance meter 9 is an illuminance measuring unit configured to measure the illuminances on a surface to be irradiated illuminated by the respective luminaires 2 to 6. The illuminance meter 9 is set, for example, on the surface to be irradiated right below the luminaires 2 to 6 when the illuminances are measured. The illuminances are measured for each of the respective luminaires 2 to 6. The illuminance meter 9 is formed to convert the measured illuminances into voltage values and output the voltage values. The illuminance meter 9 is connected to the dimming signal output device 12 and outputs the measured illuminances to the dimming signal output device 12. Note that the illuminance measuring unit is not limited to the illuminance meter 9. Sensors that detect measurement values correlated to the illuminances on the surface to be irradiated may be used as the illuminance measuring unit.

The operation devices 10 and 11 are also referred to as controllers and respectively include not-shown operators such as faders or encoders, which are manually operated. The operation devices 10 and 11 are formed to output, to the dimming signal output device 12, dimming signals corresponding to dimming operation levels by the operation of the operators. Note that one of the operation devices 10 and 11 may be connected to the dimming signal output device 12. A plurality of operation devices may be connected to the dimming signal output device 12.

The dimming signal output from the operation device 10 or 11 is, for example, a DMX signal having 256 gradations. The DMX signal is a digital signal used, for example, in the production field specified by The United States Institute for Theatre Technology (USITT) and indicates DMX512 used as the standard of a dimming signal for dimming control. 0 to 255 gradations of the DMX signal correspond to dimming levels 0 to 100% of the halogen lamp 14 and the light-emitting diodes 13.

The dimming signal output device 12 generates dimming control signals for dimming and lighting the halogen lamp 14 of the luminaire 3 and the light-emitting diodes 13 of the luminaires 2 and 4 to 6 from the dimming signal (the DMX signal) output from the operation device 10 or 11 and outputs the dimming control signals. The dimming control signals may be the DMX signals output from the operation device 10 or 11. In this embodiment, DMX signals are output as the dimming control signals.

The DMX signal output from the dimming signal output device 12 is directly input to the luminaire 2. The DMX signal output from the dimming signal output device 12 is input to a node 15 that converts an Ethernet protocol and a DMX signal bilaterally. A signal of the Ethernet protocol (hereinafter referred to as Ethernet signal) output from the node 15 is input to the luminaire 6 and a node 17, which is a bilateral converter for the Ethernet protocol and the DMX signal, by a switching hub 16. The DMX signal output from the node 17 is input to the dimming control devices 7 and 8 and the luminaire 5. The luminaires 2 and 5 and the dimming control devices 7 and 8 can analyze the DMX signals. The luminaire 6 cannot analyze the DMX signal and can analyze the Ethernet signal. A large-capacity dimming control signal can be transmitted at high speed by transmitting the dimming control signal as the Ethernet signal.

The dimming control signals output from the dimming signal output device 12 are transmitted to the plurality of luminaires 2 to 6 through different transmission routes. Optical outputs of the light-emitting diodes 13 and the halogen lamp 14, which are the light sources, are controlled. The plurality of luminaires 2 to 6 are provided to correspond to equipment such as the node 15, the switching hub 16, and the node 17, which are already set or are to be set as appropriate.

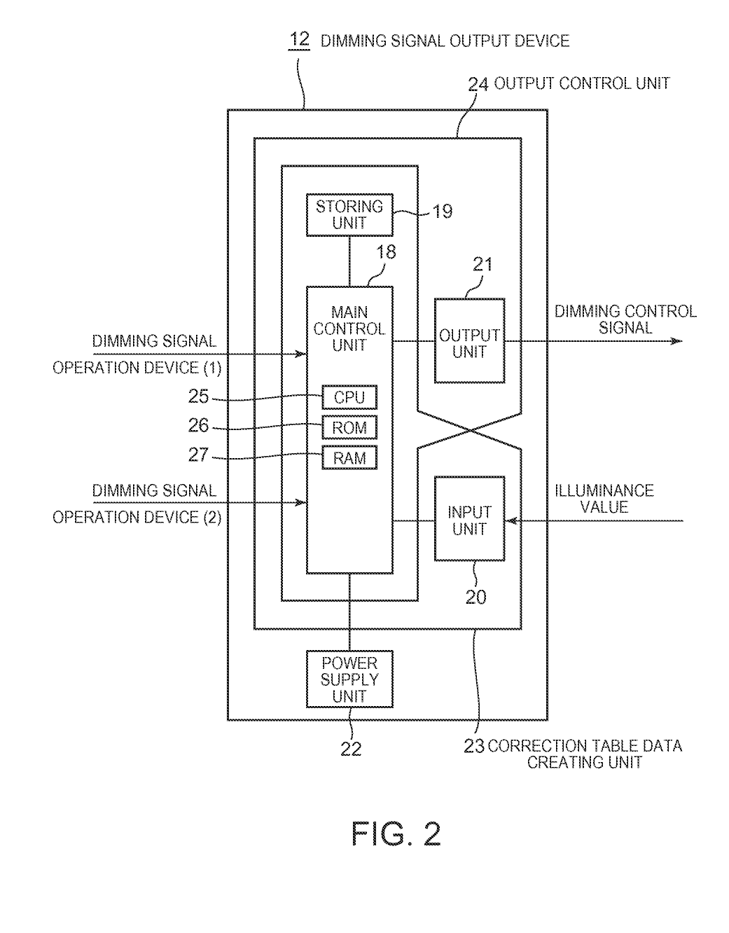

The dimming signal output device 12 includes, as shown in FIG. 2, a main control unit 18, a storing unit 19, an input unit 20, an output unit 21, and a power supply unit 22. The dimming signal output device 12 includes, for example, a not-shown display unit such as a display screen. A correction-table-data creating unit 23 is formed by the main control unit 18, the storing unit 19, and the input unit 20. An output control unit 24 is formed by the main control unit 18, the storing unit 19, and the output unit 21. The power supply unit 22 generates direct-current power supply from a not-shown alternating-current power supply and supplies driving power supply to the main control unit 18 and the like.

The main control unit 18 includes a microcomputer. A CPU (central processing unit) 25 performs various kinds of arithmetic operations and control operations on the basis of programs stored in a ROM 26. When the dimming signal (the DMX signal) is input from the operation device 10 or 11, the main control unit 18 outputs a dimming control signal, in this embodiment, a DMX signal corresponding to the dimming signal from the output unit 21 to the luminaire 2 and the node 15 side. The main control unit 18 creates correction table data and causes the storing unit 19 to store the correction table data. The creation of the correction table data is performed in the beginning. The correction table data is the data indicating the output timing of the dimming control signals from the output unit 21 to the respective luminaires 2 to 6 corresponding to the dimming signal output from the operation device 10 or 11.

The correction table data is created by respectively measuring illuminances for dimming signals for the respective luminaires 2 to 6. First, in the operation device 10 or the operation device 11, one of the plurality of luminaires 2 to 6 is selected. For example, first, the luminaire 2 is selected and a dimming signal (a DMX signal) for full (100%)-lighting the light-emitting diode 13 of the luminaire 2 is output. At this point, the illuminance meter 9 is set on the surface to be irradiated right below the selected luminaire 2.

The main control unit 18 of the dimming signal output device 12 causes, on the basis of a program, the output unit 21 to output, for example, a DMX signal of 255 gradation as a dimming control signal. The DMX signal is directly input to the luminaire 2. One cycle time of the dimming control signal is, for example, 20 ms.

The lighting circuit of the luminaire 2 supplies, according to the input DMX signal, an electric current for full lighting to the light-emitting diode 13. The light-emitting diode 13 is lit and builds up from a dimming level 0% to 100%. The illuminance right below the luminaire 2 increases according to the build-up of the dimming level of the light-emitting diode 13 and reaches a maximum illuminance value when the dimming level is 100%.

The illuminance right below the luminaire 2 is measured by the illuminance meter 9, input to the input unit 20 of the dimming signal output device 12, and input from the input unit 20 to the main control unit 18. The illuminance input to the main control unit 18 increases from a point when the DMX signal (the dimming control signal) is output from the output unit 21 and reaches the maximum illuminance,

The main control unit 18 calculates an illuminance ratio to a specific dimming level of the light-emitting diode 13 by dividing illuminance input at the dimming level time by the maximum illuminance and calculates a delay time from a point when the dimming control signal (DMX signal) is output from the output unit 21 until the light-emitting diode 13 reaches the illuminance ratio of the specified dimming level. The specific dimming level can be set to, for example, a dimming level at an interval of 0% to 10% or a dimming level at an interval of 20%. The specific dimming level may be a dimming level of 100%. In the calculation of the illuminance ratio, the main control unit 18 subtracts illuminance at the dimming level 0% from the input illuminance. That is, when the dimming level is 0%, the light-emitting diode 13 is in an extinguished state. An illuminance value measured by the illuminance meter 9 at this point is an illuminance value of external light or the like. Therefore, the main control unit 18 subtracts, for each specific dimming level, illuminance by the external light from the measurement value. The main control unit 18 causes a RAM 27 to store the input illuminance and causes the RAM 27 to store a calculated value as well,

In this way, the delay time from the output point of the dimming control signal from the output unit 21 until the light-emitting diode 13 reaches the specific dimming level (the specific illuminance ratio) is calculated. The dimming control signal is directly input to the lighting circuit of the luminaire 2. The light-emitting diode 13 substantially instantaneously builds up from extinction (the dimming level 0%) to full lighting (the dimming level 100%). Therefore, the delay time from the output point of the dimming control signal until the light-emitting diode 13 reaches the specific dimming level 100% is substantially the same as a driving time from the point when the lighting circuit inputs the dimming control signal until the electric current for full lighting is supplied to the light-emitting diode 13. In this embodiment, the delay time is, for example, 10 milliseconds (ms).

Subsequently, in the operation device 10 or the operation device 11, for example, the luminaire 3 is selected and a dimming signal (a DMX signal) for full (100%)-lighting the halogen lamp 14 of the luminaire 3 is output. At this point, the illuminance meter 9 is set on the surface to be irradiated right below the selected luminaire 3.

In the same manner as the calculation of the delay time for the luminaire 2, the main control unit 18 calculates, for the luminaire 3, a delay time from the output point of the dimming control signal until the halogen lamp 14 reaches a specific dimming level (a specific illuminance ratio). As shown in FIG. 1, the node 15, the switching hub 16, the node 17, and the dimming control device 7 are interposed between the luminaire 3 and the dimming signal output device 12.

The node 15 converts the DMX signal into the Ethernet signal and outputs the Ethernet signal taking, for example, a delay time of 20 ms. The switching hub 16 takes, for example, 10 ms to distribute and output the Ethernet signal to the node 17 and the luminaire 6. The node 17 converts the Ethernet signal into the DMX signal and outputs the DMX signal taking, for example, a delay time of 20 ms. After the input of the DMX signal, the dimming control device 7 controls dimming of the halogen lamp 14 taking, for example, 10 ms. The halogen lamp 14 builds up from extinction (the dimming level 0%) to the full lighting (the dimming level 100%) taking, for example, 30 ms. Therefore, in the luminaire 3, the delay time from the output point of the dimming control signal until the halogen lamp 14 reaches the specific dimming level 100% (the specific illuminance ratio 100%) is 90 ms in this embodiment,

Thereafter, subsequently, for the luminaires 4 to 6, delay times from the output point of the dimming control signals until the light-emitting diodes 13 reach specific dimming levels (specific illuminance ratios) are calculated in the same manner as explained above. The node 15, the switching hub 16, the node 17, and the dimming control device 8 are interposed between the luminaire 4 and the dimming signal output device 12. The dimming control device 8 takes, for example, 5 ms to convert a DMX signal into a PWM control signal and output the PWM control signal. The lighting circuit of the luminaire 4 controls lighting of the light-emitting diode 13 taking, for example, 5 ms. Therefore, in the luminaire 4, the delay time from the output point of the dimming control signal until the light-emitting diode 13 reaches the specific dimming level 100% (the specific illuminance ratio 100%) is 60 ms in this embodiment.

The node 15, the switching hub 16, and the node 17 are interposed between the luminaire 5 and the dimming signal output device 12. The lighting circuit of the luminaire 5 controls lighting of the light-emitting diode 13 taking, for example, 5 ms. Therefore, in the luminaire 5, the delay time from the output point of the dimming control signal until the light-emitting diode 13 reaches the specific dimming level 100% (the specific illuminance ratio 100%) is 55 ms in this embodiment. The node 15 and the switching hub 16 are interposed between the luminaire 6 and the dimming signal output device 12. The lighting circuit of the luminaire 6 controls lighting of the light-emitting diode 13 taking, for example, 10 ms. Therefore, in the luminaire 6, the delay time from the output point of the dimming control signal until the light-emitting diode 13 reaches the specific dimming level 100% (the specific illuminance ratio 100%) is 40 ms in this embodiment. Hereinafter, the specific dimming level is regarded as the specific illuminance ratio.

In this way, the delay times corresponding to the specific illuminance ratios (the specific dimming levels) are respectively calculated for the plurality of luminaires 2 to 6. In this embodiment, the main control unit 18 sets, as a reference value, a longest delay time among the delay times corresponding to the specific illuminance ratio 100%. That is, the luminaire 3 including the halogen lamp 14 among the plurality of luminaires 2 to 6 is selected. The delay time 90 ms of the selected luminaire 3 is set as a reference value. The main control unit 18 calculates differences between the delay times and the reference values of the respective luminaires 2 to 6, creates a correction table data for the plurality of luminaires 2 to 6 from the differences as shown in Table 1, and causes the storing unit 19 to store the correction table data. The differences for the luminaires 2 to 6 are respectively 80 ms, 0 ms, 30 ms, 35 ms, and 50 ms. In Table 1, the plurality of luminaires 2 to 6 are represented by the channels 1 to 5.

TABLE 1

| | Specific | | Difference |
|---|---|---|---|
| Luminaire | illuminance | Delay time | (correction value) |
| channel | ratio (%) | (ms) | (ms) |
| 1 | 100 | 10 | 80 |
| 2 | 100 | 90 | 0 |
| 3 | 100 | 60 | 30 |
| 4 | 100 | 55 | 35 |
| 5 | 100 | 40 | 50 |

In this way, the correction table data is created by the correction-table-data creating unit 23. After the creation, the illuminance meter 9 and the input unit 20 of the dimming signal output device 12 are disconnected.

When a dimming signal is input from the operation device 10 or 11, the main control unit 18 generates dimming control signals, in this embodiment, DMX signals corresponding to the dimming signal, reads out the correction table data from the storing unit 19, and outputs the generated dimming control signals at timings based on the differences of the correction table data. That is, the main control unit 18 is formed to, after outputting the dimming control signal to the luminaire 3 (the channel 2), output the dimming control signal to the luminaire 4 (the channel 3) after the elapse of 30 ms, output the dimming control signal to the luminaire 5 (the channel 4) after the elapse of 35 ms, output the dimming control signal to the luminaire 6 (the channel 5) after the elapse of 50 ms, and output the dimming control signal to the luminaire 2 (the channel 1) after the elapse of 80 ms.

As explained above, the correction-table-data creating unit 23 and the output control unit 24 include the main control unit 18 (the microcomputer). Therefore, the control of the plurality of luminaires 2 to 6 in this embodiment is determined according to a result of illumination.

Action of the first embodiment is explained,

When a dimming signal (a DMX signal) having a dimming gradation corresponding to a dimming operation level of the operator is output from the operation device 10 or the operation device 11, the main control unit 18 of the dimming signal output device 12 calculates dimming control signals, in this embodiment, DMX signals corresponding to the dimming signal and reads out the correction table data from the storing unit 19. The main control unit 18 outputs the calculated dimming control signals from the output unit 21 at timings based on the differences of the correction table data. That is, the main control unit 18 outputs the dimming control signal to the luminaire 3 and outputs the dimming control signals to the luminaire 4, the luminaire 5, the luminaire 6, and the luminaire 2 respectively after the elapse of 30 ms, 35 ms, 50 ms, and 80 ms from the point of the output of the dimming control signal to the luminaire 3.

When the dimming control signals are signals of the dimming level 100%, delay times from the output points of the dimming control signals to the plurality of luminaires 2 to 6 until the luminaires 2 to 6 reach the illuminance ratio 100% (the dimming level 100%) are respectively 10 ms, 90 ms, 60 ms, 55 ms, and 40 ms as shown in Table 1. That is, the luminaire 4 reaches the illuminance ratio 100% earlier than the luminaire 3 by 30 ms. The luminaires 5, 6, and 2 respectively reach the illuminance ratio 100% earlier by 35 ms, 50 ms, and 80 ms. Therefore, if the dimming control signals are respectively output to the luminaires 4, 5, 6, and 1 with delays of 30 ms, 35 ms, 50 ms, and 80 ms from the output point of the dimming control signal to the luminaire 3, the plurality of luminaries 2 to 6 reach the illuminance ratio 100% at substantially the same timings. Consequently, a sense of discomfort and the like due to an illuminance change of the plurality of luminaires 2 to 6 are suppressed.

Even if the dimming control signals are signals of a dimming level other than the dimming level 100% (the illuminance ratio 100%), inconsistency of the lighting timings at the illuminance ratio in the plurality of luminaires 2 to 6 is suppressed. That is, at the specific illuminance ratio 100%, since the luminaires 4 and 5 have the shortest delay time 5 ms and the luminaire 3 has the longest delay time 30 ms, there is a delay time difference of maximum 25 ms among the luminaires 2 to 6.

On the other hand, the respective delay times of the node 15, the switching hub 16, the node 17, and the dimming control device 7 or the dimming control device 8 interposed between the dimming signal output device 12 and the plurality of luminaires 2 to 6 are, for example, 20 ms, 10 ms, 20 ms, 10 ms, and 5 ms. A total delay time of the delay times is considerably larger than the delay time difference among the plurality of luminaires 2 to 6 and is a fixed value. Therefore, fluctuation in the lighting timing of the plurality of luminaires 2 to 6 is not substantially different from fluctuation of the lighting timings that occurs when the dimming control signals have the dimming level 100% (the illuminance ratio 100%).

With the light dimming system 1 in this embodiment, the dimming control signals are respectively output to the plurality of luminaires 2 to 6 side at the timings based on the differences of the correction table data. Therefore, there is an effect that the plurality of luminaires 2 to 6 that include the diodes 13 and the halogen lamp 14, which are different kinds of light sources, and to which the dimming control signals are transmitted via different transmission routes can suppress inconsistency of lighting timings at changed dimming levels.

In this embodiment, the correction-table-data creating unit 23 creates the correction table data from the differences at the specific illuminance ratio 100%. The output control unit 24 outputs the dimming control signals from the output unit 21 at the timing of the differences. However, the correction-table-data creating unit 23 and the output control unit 24 are not limited to this. The correction-table-data creating unit 23 may set, for example, 10%, 20%, . . . , 70%, 80%, 90%, and 100% as specific illuminance ratios, calculates differences at the specific illuminance ratios, and creates a correction table data from the differences. The output control unit 24 may output dimming control signals at timings based on differences of specific illuminances closest to illuminance ratios (dimming levels) given to the dimming control signals.

The plurality of luminaires 2 to 6 include the light-emitting diodes 13 and the halogen lamp 14, which are different kinds of light sources. However, the plurality of luminaires 2 to 6 are not limited to this. The plurality of luminaires 2 to 6 may include the same kind of light sources. Dimming control signals for controlling optical outputs of the light sources may be transmitted to the plurality of luminaires 2 to 6 via different transmission routes. That is, in at least two among the plurality of luminaires 2 to 6, delay times from an output point of the dimming control signals until the luminaires 2 to 6 reach specific illuminance ratios only have to be different.

The operation devices 10 and 11 and the dimming signal output device 12 may be configured as an integrated dimming operation device, for example, a dimming table.

A second embodiment is explained.

In this embodiment, the main control unit 18 sets an illuminance ratio lower than 100%, for example, 70% as a specific illuminance ratio for the luminaire 3 having the longest delay time and sets, as a reference value, a delay time, for example, 70 ms from an output point of a dimming control signal until the luminaire 3 reaches the illuminance ratio 70% in the first embodiment. The reference value is set to be longer than delay times at the specific illuminance ratio 100% of the other luminaires 2 and 4 to 6. That is, the specific illuminance ratio for the luminaire 3 is set in that way. The correction-table-data creating unit 23 creates correction table data from differences between the delay times of the respective luminaires 2 to 6 and the reference value (70 ms) as shown in Table 2.

TABLE 2

| | Specific | | Difference |
|---|---|---|---|
| Luminaire | illuminance | Delay time | (correction value) |
| channel | ratio (%) | (ms) | (ms) |
| 1 | 100 | 10 | 60 |
| 2 | 70 | 70 | 0 |
| 3 | 100 | 60 | 10 |
| 4 | 100 | 55 | 15 |
| 5 | 100 | 40 | 30 |

According to this embodiment, there is an effect that it is possible to suppress fluctuation in lighting timings of the plurality of luminaires 2 to 6 with respect to the illuminance ratios of the dimming control signals and reduce times until the luminaires 2 and 4 to 6 excluding the luminaire 3 having the longest delay time set as the reference value are lit at the illuminance ratios of the dimming control signals.

A third embodiment is explained.

In this embodiment, the main control unit 18 sets, as a reference value, a delay time shorter than the longest time 90 ms among the delay times of the plurality of luminaires 2 to 6 at the specific illuminance ratio 100% in the first embodiment. That is, in this embodiment, the luminaires 3 to 5 are luminaires having longer delay times. The luminaire 5 having the shortest delay time among the luminaires 3 to 5 is selected. The delay time 55 ms of the selected luminaire 5 is set as a reference value. For the luminaires 3 and 4 having delay times longer than the reference value, the delay times are regarded as reference values. The correction-table-data creating unit 23 creates correction table data for the plurality of luminaires 2 to 6 from differences between the delay times of the respective luminaires 2 to 6 and the reference value (55 ms) as shown in Table 3.

TABLE 3

| | Specific | | Difference |
|---|---|---|---|
| Luminaire | illuminance | Delay time | (correction value) |
| channel | ratio (%) | (ms) | (ms) |
| 1 | 100 | 10 | 45 |
| 2 | — | — | 0 |
| 3 | — | — | 0 |
| 4 | 100 | 55 | 0 |
| 5 | 100 | 40 | 15 |

According to this embodiment, there is an effect that it is possible to suppress fluctuation in lighting timings of the plurality of luminaires 2 to 6 with respect to the illuminance ratios of the dimming control signals and reduce times until the luminaires 2 and 6 excluding the luminaires 3 to 5 having the longer delay times are it at the illuminance ratios of the dimming control signals.

While certain embodiments have been described, these embodiments have been presented by way of example only, and are not intended to limit the scope of the inventions. Indeed, the novel embodiments described herein may be embodied in a variety of other forms; furthermore, various omissions substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A light dimming system comprising:
a plurality of luminaires to which dimming control signals are transmitted via different transmission routes to have optical outputs of light sources thereof controlled and/or that include different kinds of light sources;
an illuminance measuring unit capable of measuring illuminances of the respective luminaires; and
a dimming signal output device including:
a main control unit;
a correction-table-data creating unit configured to calculate, on the basis of the illuminances measured by the illuminance measuring unit, delay times until the luminaires reach specific illuminance ratios, set the delay time of selected one of the luminaires as a reference value, create correction table data from differences between the delay times for the plurality of luminaires and the reference value, and store the correction table data; and
an output control unit configured to output the dimming control signals to the plurality of luminaires side at timings based on the differences of the correction table data,

2. The system according to claim 1, further comprising an operation device configured to output a dimming signal corresponding to a dimming operation level.

3. The system according to claim 2, wherein dimming control signals corresponding to a dimming signal output from the operation device are transmitted to the luminaires via different transmission routes to have the optical outputs of the light sources thereof controlled.

4. The system according to claim 2, wherein the main control unit outputs dimming control signals corresponding to a dimming signal output from the operation device.

5. The system according to claim 1, wherein, when the light sources of the respective luminaires are it according to a dimming signal, the correction-table-data creating unit calculates, on the basis of the illuminances measured by the illuminance measuring unit, delay times from an output point of the dimming control signals until the luminaires reach the specific illuminance ratios.

6. The system according to claim 1, wherein the correction-table-data creating unit sets, as the reference value, a delay time of the luminaire having a longest delay time,

7. The system according to claim 1, wherein the correction-table-data creating unit sets, as the reference value, a delay time corresponding to an illuminance ratio lower than the specific illuminance ratio in the luminaire corresponding to a longest delay time.

8. The system according to claim 1, wherein the correction-table-data creating unit sets, as the reference value, a delay time of the luminaire having a delay time shorter than a longest delay time, regards a delay time longer than the reference value as the reference value, and creates the correction table data from the differences.

9. A light dimming system comprising:
an operation device configured to output a dimming signal corresponding to a dimming operation level;
a plurality of luminaires to which dimming control signals corresponding to the dimming signal output from the operation device are transmitted via different transmission routes to have optical outputs of light sources thereof controlled and/or that include different kinds of light sources;
an illuminance measuring unit capable of measuring illuminances on a surface to be irradiated by the respective luminaires; and
a dimming signal output device including:
a main control unit configured to output the dimming control signals corresponding to the dimming signal output from the operation device;
a correction-table-data creating unit configured to calculate, on the basis of the illuminances measured by the illuminance measuring unit when the light sources of the respective luminaires are it according to the dimming signal, delay times from an output point of the dimming control signals until the luminaires reach specific illuminance ratios, set the delay time of selected one of the luminaires as a reference value, create correction table data from differences between the delay times for the plurality of luminaires and the reference value, and store the correction table data; and
an output control unit configured to output the dimming control signals to the plurality of luminaires side at timings based on the differences of the correction table data.

10. The system according to claim 9, wherein the correction-table-data creating unit sets, as the reference value, a delay time of the luminaire having a longest delay time.

11. The system according to claim 9, wherein the correction table-data creating unit sets, as the reference value, a delay time corresponding to an illuminance ratio lower than the specific illuminance ratio in the luminaire corresponding to a longest delay time.

12. The system according to claim 9, wherein the correction-table-data creating unit sets, as the reference value, a delay time of the luminaire having a delay time shorter than a longest delay time, regards a delay time longer than the reference value as the reference value, and creates the correction table data from the differences.
